(19) United States
(12) Patent Application Publication
(10) Pub. No.: US 2010/0094952 A1
(43) Pub. Date: Apr. 15, 2010

(54) Method and Apparatus for Notifying Clients in a Communication Network

(76) Inventors: Anders Lindgren, Alvsjo (SE); Christer Boberg, Tungelsta (SE)

Correspondence Address: ERICSSON INC., 6300 LEGACY DRIVE, M/S EVR 1-C-11, PLANO, TX, 75024, US

(21) Appl. No.: 12/530,850

(22) PCT Filed: Mar. 19, 2007
(86) PCT No.: PCT/SE2007/000267

§ 371 Date: Nov. 24, 2009

(51) Int. Cl. G06F 15/16

(52) U.S. Cl. 709/219; 709/227

(57) ABSTRACT

A method, information delivery server, and client data server for providing client data regarding an observed client to plural watching clients. The client data server has knowledge of which watching clients subscribe to watch the observed client. The client data server sends a single notification message to the information delivery server and includes client data of the observed client and identifiers of the subscribing watching clients. The information delivery server may customize the client data according to one or more delivery rules and data filters for delivery to the identified watching clients in individual customized notification messages.

### TECHNICAL FIELD

The present invention relates generally to a method and apparatus for notifying a plurality of watching clients on events related to an observed client in a communication network.

### BACKGROUND

With the emergence of 3G mobile telephony, new packet-based communication technologies using IP (Internet Protocol) have been developed to support wireless communication of multimedia. For example, communication protocols in GPRS (General Packet Radio Service) and WCDMA (Wideband Code Division Multiple Access) support packet-switched multimedia services, as well as traditional circuit-switched voice calls.

A network architecture called “IP Multimedia Subsystem” (IMS) has been developed by the 3^{rd} Generation Partnership Project (3GPP) as a platform for handling multimedia services and sessions in the packet domain, based on IP transport. Thus, an IMS network can be used to initiate and control multimedia sessions for any IP enabled terminals being connected to any type of access networks. The sessions are controlled by various session managing nodes in the IMS network, including the well-known IMS nodes S-CSCF (Serving Call Session Control Function), I-CSCF (Interrogating Call Session Control Function) and P-CSCF (Proxy Call Session Control Function). Further, a main database element HSS (Home Subscriber Server) stores subscriber data and authentication data for subscribing clients.

The signalling protocol called “SIP” (Session Initiation Protocol) is typically used for controlling multimedia sessions in IMS networks and other service networks. SIP-enabled terminals and servers can thus use this protocol to initiate and terminate communications of multimedia, e.g. by means of an IMS network. Although various embodiments will be generally described below in terms of IMS and SIP, any other suitable types of service networks and protocols can be used for session control when implementing the present invention.

The multimedia services are enabled and executed by various application servers that may reside within or outside the IMS network. A particular example of services that can be employed by means of an IMS network or other service networks is the so-called “presence” services which basically make data related to a specific client available to other clients.

In this description, the general term “client data” is used to represent any information on the state or situation of a client and his/her equipment, although the corresponding term “presence data” is typically used for presence services. Client data is maintained at an application server, generally referred to as a “client data server”, serving the client in question. In terms of presence services, presence data of a client is stored in a presence server, and it can then be supplied to clients subscribing to that presence data.

The client data or presence data may refer to the following exemplary client states:
A personal status, e.g. available, busy, in a meeting, on holiday, etc.
A terminal status, e.g. switched on/off, engaged, out of coverage, etc.
The geographic location of the client/terminal.
Terminal capabilities, e.g. functionality for SMS, MMS, chat, IM, video, etc.
Terminal selections, e.g. call forwarding, language, etc.
Other client information, e.g. interests, occupations, personal characteristics, moods, personal logos, logo depending on the current mood, etc.

This type of information is thus continually stored in, e.g., presence servers based on publications of so-called “client events” received from clients or from their access networks, whenever any presence data for a client is introduced, updated, changed or deleted. A client may thus also subscribe for selected presence data of one or more other clients which is also handled by an application server.

In this description, the term “client” generally represents a communication terminal and its user. Further, a “watching client” is a client that subscribes or requests for presence data (sometimes referred to as the “Watcher”), and an “observed client” is a client that publishes presence data (sometimes referred to as the “Presentity”) to be available for any authorised watching clients.

A SIP message called “SIP PUBLISH” is generally used by observed clients to send their presence data to the presence server for publication. The SIP PUBLISH message can be used to initiate new data, modify existing data, “refresh” existing data (i.e. confirming that the data continues to be valid), and to terminate existing data not valid anymore.

Another SIP message called “SIP SUBSCRIBE” is used by watching clients to subscribe for presence data of observed clients, and only authorised clients are entitled to receive such data. The SIP SUBSCRIBE message typically contains a time-out parameter, or TTL (Time To Live), that can be set by the watching client to determine when to end the subscription and notifications. Yet another SIP message called “SIP NOTIFY” can be used by presence servers to provide updated presence data to subscribing clients.

As mentioned above, the mechanisms above for publishing client data and providing notifications of published client data to watching clients can be used in presence services, but also in other services such as PoC (Push-to-talk over Cellular) and IM (Instant Messaging).

FIG. 1 illustrates the present conventional procedure for providing presence data, involving a watching client A, an observed client B, and a presence server 100 acting for client B. The presence data for client B is maintained in a presence database 102 associated with presence server 100, and presence rules for controlling data delivery are stored in a rules database 104. The presence rules may dictate what data is accessible to whom, etc. In the figure, clients A and B are represented by mobile terminals even though the described procedure can be applied for fixed terminals as well.

A first step 1:1a generally illustrates that the observed client B publishes presence data by sending SIP PUBLISH messages to the presence server 100. Certain data for client B can also be sent from client B's access network (not shown), e.g. location data and terminal status data. A next step 1:1b illustrates that presence database 102 is updated with the new data received in the publications of step 1:1a. Basically, steps 1:1a and 1:1b continue throughout in the background whenever presence data is published for client B, according to prevailing routines.

Client A can subscribe for presence data by establishing a dialogue with the presence server 100 in which notifications can be received. In a step 1:2, client A thus sends an SIP SUBSCRIBE message requesting presence data of client B, and a time-out parameter TTL is also specified in the message for the dialogue. If the TTL is set to zero client A will receive presence data of client B just once, and if the time-out parameter is set to a desired time duration he/she will receive presence data on a continuous basis. The SIP SUBSCRIBE message in step 1:2 may also contain client A's preferences on what type of information he/she wants to receive or not receive, which will be referred to as a “data filter” for short in the following. For example, client A may be interested in the whereabouts (location) of client B, but not in his/her current mood or terminal settings, etc.

The presence server 100 then applies any prevailing presence rules by checking database 104, to determine if client A is authorised to receive certain available presence data of client B, in a next step 1:3. If so, the presence data of client B available to client A, is retrieved from database 102 in a step 1:4. Furthermore, the data filter (if any) according to the subscription request of step 1:2, is applied in a following step 1:5, and the data is finally sent to client A in a notification message SIP NOTIFY, as shown in a step 1:6. The presence data delivered in step 1:6 may thus be allowed/restricted according to prevailing presence rules in the rules database 104 and/or filtered according to a data filter received from client A.

As indicated by the further dashed arrows in step 1:6, client A may receive such notifications with presence data on further occasions during the subscription period, either regularly or whenever the presence data of B is changed. In order to prolong or “refresh” the subscription, client A may send another SIP SUBSCRIBE message just before the TTL expires, and the presence server 100 will then maintain the subscription and deliver further notifications.

A watching client often subscribes for presence data of a substantial number of observed clients. In order to reduce the notification traffic to a particular watching client, an information delivery server can be used called the RLS, “Resource List Server”, collecting notifications of the observed clients by means of so-called “back-end subscriptions”, and sends a common notification to the watching client for all observed clients. This mechanism is referred to as the “exploder” function, and in the case of mobile watching clients it is desirable to reduce the message traffic over the radio interface in this way.

FIG. 2 illustrates an RLS 200 providing presence data to a watching client A on a group of observed clients B,C and D, according to the prior art. It is assumed that presence data of clients B,C and D is published and stored in their respective presence servers 202B, 202C and 202D, as illustrated by arrows p. RLS 200 is also connected to a user list server 204 maintaining various predefined user lists such as phone books and contact groups. A watching client may also request for presence data of clients in an ad hoc group specified in the request message.

In a first shown step 2:1, terminal A sends a SIP SUBSCRIBE message requesting presence data on the group of clients B,C,D as indicated by referring to a predefined user list. According to SIP, this message may be configured as: event:Presence,list=1. In response thereto, RLS 200 fetches the requested user list from user list server 204, in a step 2:2, the, list thus identifying the observed clients B-D and their presence servers 202B-D. The SIP SUBSCRIBE message may also contain a data filter as described for step 1:2 in FIG. 1 above.

Thereafter, RLS 200 subscribes for data from each of the application servers 202B-D for their respective clients by means of back-end subscriptions, as generally illustrated by steps 2:3, 2:4 and 2:5. Each back-end subscription also includes the data filter, if received in step 2:1 above. After having collected presence data from servers 202B-D, optionally by applying the data filter if required, RLS 200 sends a common notification to client A, in a final step 2:6, containing desired presence data of all clients B-D in the list. The delivered data may thus have been allowed/restricted and/or filtered in the manner described above, although not shown here. Further notifications with presence data of clients B-D may be delivered to client A during the subscription period, as similar to the example of FIG. 1.

However, the amount of notifications being sent from the presence servers to the RLS can be huge, according to various ongoing back-end subscriptions on behalf of watching clients, imposing great load on resources for transmitting and processing these notifications.

FIG. 3 illustrates this problem when an RLS 300 provides presence data of an observed client B to a plurality of watching clients A₁, A₂ and A₃, according to the prior art. In this example, only three watching clients are shown, but it should be understood that a much greater number of watching clients may be interested in presence data of the same observed client, e.g. in the magnitude of hundreds of watching clients.

In FIG. 3, it is assumed that watching clients A₁, A₂ and A₃ have already requested presence data of the observed client B, presumably independent of each other, and that RLS 300 has established back-end subscriptions with a presence server 302 maintaining presence data for client B, i.e. one back-end subscription for each watching client. RLS 300 has also supplied data filters according to preferences of the watching clients to presence server 302. Thus, each watching client may want presence data according to his/her own data filter. Moreover, the watching clients may have differentiated access to the presence data of client B, as dictated by presence rules in a rules database 304 associated with server 302.

A first step 3:1 generally illustrates that presence data of client B is published and stored in server 302, which may result in notifications to all the watching clients. Notifications may also be delivered on a regular basis regardless of when the presence data is published. A next step 3:2 illustrates that rules from the rules database 304 are applied for the watching clients before delivery. Any data filters 306 are also applied on the presence data individually for the watching clients, in a step 3:3.

Then, presence server 302 sends presence data of client B to RLS 300 in notifications for each watching client, according to the back-end subscriptions. Thus, the presence data which has been allowed/restricted and/or filtered individually for the watching clients in steps 3:2 and 3:3 above may differ in these notifications. In this example, step 3:4 illustrates a notification from server 302 processed according to a rule R₁ and data filter F₁ valid for client A₁, step 3:5 illustrates a notification processed according to a rule R₂ and data filter F₂ valid for client A₂, and step 3:6 illustrates a notification processed according to a rule R₃ and data filter F₃ valid for client A₃.

Finally, RLS 300 delivers the individual notifications described above to watching clients A₁, A₂ and A₃, in steps 3:7, 3:8 and 3:9. Although not illustrated here, any of the watching clients A₁, A₂ and A₃ may of course also receive presence data of further observed clients in the same notification from the RLS 300, in the manner described for FIG. 2 above. Moreover, the notifications in steps 3:7, 3:8 and 3:9 may be delivered independently at different points.

As shown in steps 3:4, 3:5 and 3:6, it is at present necessary to send a separate notification for each watching client A₁, A₂ and A₃ from the presence server 302 to the RLS 300 with presence data being published for the same observed client B. As mentioned above, this may result in a huge number of notifications being communicated and processed by these nodes if many watching clients are involved, even though these notifications may well contain the same information.

It is therefore desirable to reduce the amount of traffic and the number of notifications, between a client data server maintaining client data for an observed client and an information delivery server delivering notifications to plural watching clients with client data published for the observed client. It is also desirable to reduce the burden of processing such notifications in both of these nodes.

### SUMMARY

The object of the present invention is to address the problems outlined above. In particular, it is an object of the present invention to provide a solution that can generally reduce the signalling and the number of messages necessary for providing notifications to plural watching clients regarding client data of the same observed client.

The present invention involves an information delivery server delivering notifications to the watching clients and a client data server maintaining client data for the observed client. The information delivery server may be an RLS and the client data server may be a presence server, although the present invention is not limited to these specific nodes.

These objects and others may be obtained by using a method and arrangement according to the attached independent claims.

According to one aspect, the present invention provides a method, executed by the information delivery server, of providing client data of an observed client to a plurality of watching clients in a communication network. Individual subscription requests for client data of the observed client are received from the watching clients. Back-end subscriptions are then created on behalf of the watching clients for client data of the observed client, with a client data server maintaining said client data. According to these back-end subscriptions, a common notification is received for the watching clients with client data of the observed client from the client data server. The client data is then customised for the watching clients by applying at least one delivery rule valid for one or more of the watching clients. Finally, the customised client data is delivered in individual notifications to the watching clients.

According to another aspect, the present invention provides an information delivery server for providing client data of an observed client to a plurality of watching clients in a communication network. The information delivery server comprises means for receiving individual subscription requests for client data of the observed client from the watching clients, and means for creating back-end subscriptions on behalf of the watching clients for client data of the observed client, with a client data server maintaining said client data.

The information delivery server further comprises means for receiving a common notification for the watching clients with client data of the observed client from the client data server, means for customising the client data for the watching clients by applying at least one delivery rule valid for one or more of the watching clients, and means for delivering the customised client data in individual notifications to the watching clients.

According to further aspects, the present invention provides a method and a client data server for providing client data of an observed client to a plurality of watching clients in a communication network by means of an information delivery server, the client data server maintaining said client data. Requests for back-end subscriptions are received from the information delivery server on behalf of the watching clients, for client data of the observed client, each back-end subscription request including an identifier of the corresponding watching client. A common notification is then sent to the information delivery server with client data of the observed client for the watching clients, such that the information delivery server can customise the client data for the watching clients before delivery.

Further features of the present invention and its benefits can be understood from the detailed description below.

### BRIEF DESCRIPTION OF THE DRAWINGS

The present invention will now be described in more detail by means of exemplary embodiments and with reference to the accompanying drawings, in which:

FIG. 1 is a block diagram illustrating a procedure for providing presence data regarding an observed client B to a watching client A, according to the prior art.

FIG. 2 is a block diagram illustrating a procedure for providing presence data to a watching client A on a group of observed clients B,C and D by means of a Resource List Server RLS, according to the prior art.

FIG. 3 is a block diagram illustrating a procedure for providing presence data of an observed client B to a plurality of watching clients A₁, A₂ and A₃ by means of a Resource List Server RLS, according to the prior art.

FIG. 4 is a block diagram illustrating a procedure for providing client data of an observed client B to a plurality of watching clients A₁, A₂ and A₃ by means of an information delivery server, according to one embodiment.

FIG. 5 is a flow chart for a procedure executed by an information delivery server when providing client data of an observed client to a plurality of watching clients, basically according to the block diagram of FIG. 4.

FIG. 6 is a flow chart for a procedure executed by a client data server when providing client data of an observed client to a plurality of watching clients by means of an information delivery server, basically according to the block diagram of FIG. 4.

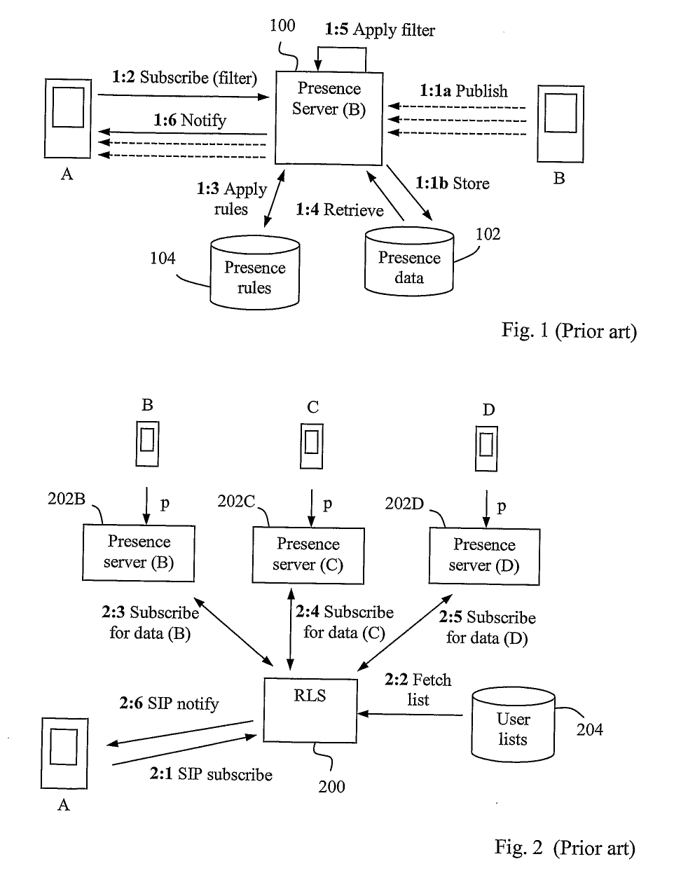

### DETAILED DESCRIPTION

Briefly described, the present invention can be used for reducing the signalling traffic between an information delivery server providing notifications with client data of an observed client to a plurality of watching clients, and a client data server of the observed client. The information delivery server may be an RLS and the client data server may be a presence server where SIP signalling is used between these nodes, although the present invention is not limited thereto.

According to this solution, client data to be delivered to the plural watching clients can be transferred once from the client data server to the information delivery server in a common notification message, instead of being transferred multiple times in individual notification messages directed to the different watching clients. The information delivery server can then extract appropriate customised client data from the common notification message for delivery to the watching clients in individual notification messages.

In different embodiments, the common notification message may also include identifiers of the watching clients and an indication of any delivery rules valid for one or more of the watching clients. Alternatively, the receiving information delivery server may be capable of identifying which watching clients are subscribing to the client data of the observed client, and of retrieving their relevant delivery rules from an accessible rules database.

The delivery rules may dictate the availability or accessibility of the client data in the common notification to the different watching clients. For example, the delivery rules may dictate that client data X should only be delivered to clients A,B,C and no-one else, and/or that client data Y must not be delivered to clients D,E,F, etc.

Furthermore, if the watching clients request for client data selectively, that is, if certain client data should be omitted from delivery according to individual data filters, these data filters can be stored and applied at the information delivery server in order to customise the client data. The term “customise” is used here to represent any adaptation of the client data content for a specific client.

Different embodiments of the present invention will now be described in more detail with reference to the following figures, without limiting the overall scope of the present invention. FIG. 4 is a block diagram illustrating an arrangement and procedure for providing client data of an observed client B to a plurality of watching clients A₁, A₂ and A₃, according to one embodiment.

It is assumed that clients A₁, A₂ and A₃ have already requested for client data of client B independent of each other by means of subscription requests, not shown, to an information delivery server 400. The information delivery server 400 may be an RLS and the subscription requests may be sent as SIP SUBSCRIBE messages. Further, a client data server 402, which may be a presence server, receives and maintains the client data of client B on a continuous basis, as shown by the dashed arrow.

One or more watching clients may also generally request for client data selectively by specifying a data filter or the equivalent in the client data requests. In practice, client data may be requested selectively in different ways, e.g. by specifying one or more types of client data that should be included or left out at delivery, which is referred to as the “data filter” in this description. Thus, the data filter generally controls what information a watching client wants to receive regarding the observed client.

In this example, each client A₁, A₂ and A₃ has specified a data filter F₁, F₂ and F₃, respectively, in his/her subscription request to information delivery server 400. A first step 4:1 illustrates that information delivery server 400 stores the data filters in a suitable data storage, as the subscription request are received one by one, in order to apply the filters later when delivering notifications to the respective watching clients.

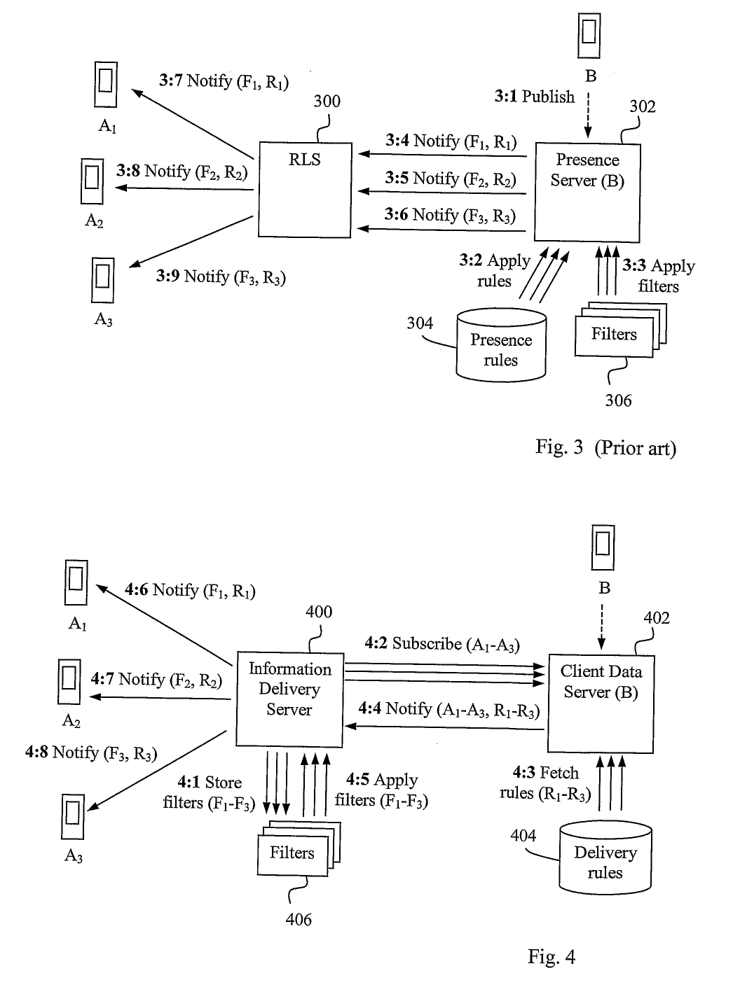

Next, information delivery server 400 establishes back-end subscriptions with client data server 402, for client data of client B on behalf of clients A₁, A₂, A₃, i.e. a separate subscription request is sent for each watching client, as shown in a schematic step 4:2. Server 400 also includes a suitable identifier of the concerned watching client in each back-end subscription request according to prevailing standards. However, it is not necessary to transmit the data filters F₁, F₂ and F₃ in the subscription requests to client data server 402, as in the conventional procedures of FIGS. 2 and 3, since the data filters can be maintained and applied by the information delivery server 400 according to this solution, as will be described below.

At this point, it is generally up to the client data server 402 to decide when to send a notification with client data of the observed client to multiple watching clients, and to which clients it should be addressed to. For example, the client data server 402 may be triggered to send a notification when new client data has been published for client B.

Client data server 402 then retrieves applicable delivery rules R₁, R₂ and R₃ from a rule database 404, which are valid for the clients A₁, A₂ and A₃, respectively, in a further step 4:3. In this schematic example, a delivery rule is retrieved for each watching client, even though the same delivery rule may be valid for more than one watching client, or some clients may not submit to any delivery rule at all, etc. It should also be noted that the delivery rules have been defined by the observed client to control the availability or accessibility of his/her client data to others, whereas the data filters have been defined as preferences by the watching clients.

In a following step 4:4, client data server 402 sends a common notification message with client data of client B to the information delivery server 400, instead of sending basically the same client data three times in individual notification messages aimed for the different watching clients. The common notification may be sent in an SIP NOTIFY message.

The common notification may also contain identifiers of the targeted clients A₁, A₂ and A₃ as well as the corresponding, valid delivery rules R₁, R₂ and R₃ retrieved in step 4:3, or at least some suitable indication thereof. For example, the common notification may include the complete rules explicitly, or implicit references to the delivery rules R₁, R₂ and R₃ instead of the complete rules themselves such that the information delivery server 400 can use these references for accessing the actual delivery rules from the rule database 404. The latter solution is viable if the servers 400 and 402 have a trusted relationship.

If no such identifiers and rules are included in the common notification, the receiving information delivery server may identify the watching clients anyway as subscribing to the client data of the observed client, and then retrieve their delivery rules from the rule database 404.

In order to save space in the common notification message, the client data server 402 may leave out any client data from the message that is anyway not allowed for any of the watching clients, as dictated by the retrieved delivery rules R₁, R₂ and R₃.

In practice, it is possible to convey the information in the common notification to the information delivery server 400 in different ways. In one alternative, a previously established SIP tunnel between the client data server and the information delivery server may be used. A solution is currently available for establishing an SIP tunnel between an RLS and a presence server for exchanging various requests in an ongoing SIP dialogue between these nodes, which can be used in this context. In another alternative, an existing ID parameter in the header of an SIP NOTIFY message can be used for providing the identifiers of all watching clients in the common notification. These two implementation alternatives will be described in more detail later below.

When receiving the common notification message, the information delivery server 400 identifies the concerned watching clients, either from the client identifiers if given in the common notification message or as being subscribers to the received client data, and retrieves the corresponding data filters F₁, F₂, F₃ stored in step 4:1, in a next step 4:5.

The information delivery server 400 then customises the client data received in the common notification message for delivery to the watching clients, by applying the delivery rules R₁, R₂, R₃ indicated in the message and the retrieved data filters F₁, F₂, F₃. It should be noted that, in general, not all watching clients are necessarily subject to such rules and filters, even though this is the case in this schematic example.

Server 400 finally delivers the customised client data in individual notification messages to the watching clients, in further steps 4:6, 4:7 and 4:8. In this way, the delivered customised client data has been individually adapted to the watching clients according to various valid delivery rules and data filters, to provide differentiated client data content in the individual notifications.

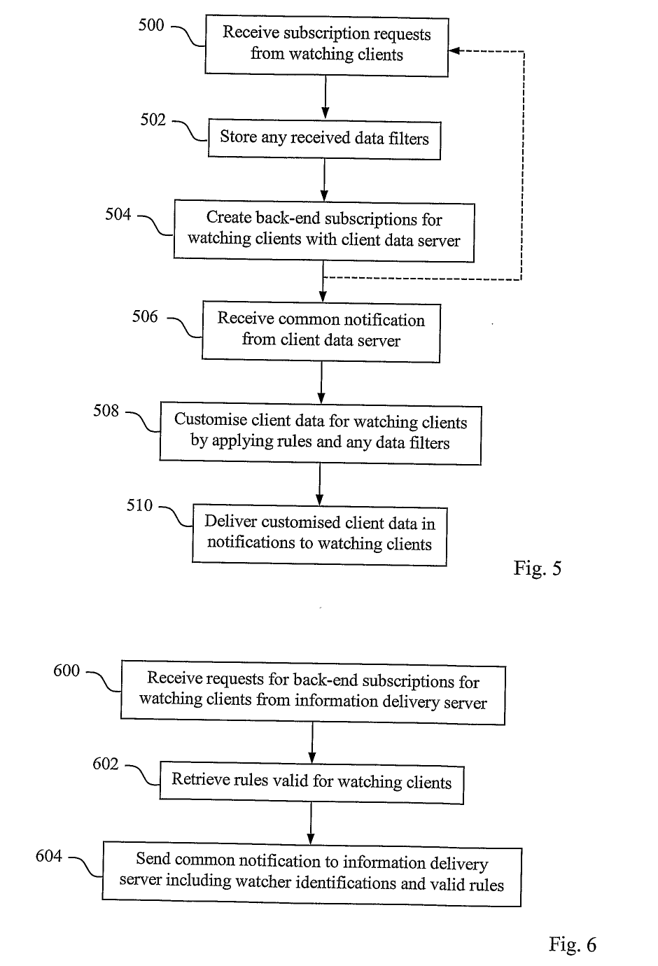

FIG. 5 is a flow chart for a procedure executed by an information delivery server when providing client data of an observed client to a plurality of watching clients, basically in accordance with the block diagram of FIG. 4. A first step 500 generally illustrates that individual subscription requests for client data of the observed client are received from the watching clients. These requests may be received independently at different points, although illustrated as a single step here. In a next step 502, any data filters received with the requests are stored by the information delivery server for later use when customising the client data content for delivery.

In response to the subscription requests of step 500, back-end subscriptions are created with a client data server of the observed client on behalf of the requesting watching clients, for client data of the observed client, in a further step 504. Basically, steps 500-504 can be repeated each time a subscription request for client data is received from a watching client, as indicated by the dashed arrow.

In response to the back-end subscriptions, a common notification message with client data of the observed client is received sooner or later from the client data server for the watching clients, in a next step 506, instead of receiving basically the same client data duplicated in plural individual notifications, e.g., as shown in steps 3:4-3:6 in FIG. 3. Thereby, duplication of the client data is avoided.

The received common notification message may include identifiers for the watching clients as well as an indication of at least one delivery rule valid for one or more watching clients, in addition to the client data of the observed client. The delivery rule indication may be one or more complete rules given explicitly, or a reference or the like representing the one or more rules implicitly by pointing to rules stored in an accessible delivery rule database or to rules predefined in a look-up table or the like. If no such identifiers and rules are included in the common notification, the receiving information delivery server will identify the watching clients as subscribing to the client data of the observed client, and then retrieve their delivery rules from the rule database.

In a next step 508, the client data contained in the common notification is customised for the watching clients by applying their corresponding data filters stored in step 502 above, if any, and also according to the at least one rule indicated in the received common notification. In a final step 510, the customised client data is delivered in individual notifications to the watching clients, thus being more or less differentiated in adaptation to the watching clients depending on their data filters and valid rules.

FIG. 6 is another flow chart for a procedure as executed by a client data server when providing client data of an observed client to a plurality of requesting watching clients by means of an information delivery server, likewise basically in accordance with the block diagram of FIG. 4. The client data server thus receives and maintains client data of the observed client, as described above.

In a first step 600, the client data server receives requests from the information delivery server for back-end subscriptions for client data of an observed client, on behalf of the requesting watching clients, e.g. as described for step 4:2 in FIG. 4. These back-end subscription requests include identifiers of the respective watching clients, and are typically received independently at different points, although illustrated as a single step here.

In a next step 602, at least one delivery rule valid for one or more of the watching clients is retrieved from a rule database, e.g., as described for step 4:3 in FIG. 4. The client data server then creates a common notification with current client data of the observed client. The common notification may also include identifiers of the watching clients and rules valid for the watching clients, if any. Finally, the client data server sends the common notification to the information delivery server in a step 604. The information delivery server can then deliver individual notifications to the watching clients, based on the common notification, as described above for steps 508 and 510 in FIG. 5.

As mentioned above, the information in the common notification can be conveyed from the client data server to the information delivery server in different ways, although the present invention is generally not limited to any particular scheme or method. However, two different viable proposals will now be described in more detail.

According to a first alternative, an SIP tunnel can be established between the client data server and the information delivery server, which is an ongoing SIP dialogue that can be utilised for communicating various messages in multiple subscriptions over that single shared dialogue. This will generally reduce the processing of overhead and memory usage at both nodes, as compared to using multiple individual SIP dialogues for the subscriptions. This mechanism can now be extended to include the additional data needed for conveying the common notification targeted to the watching clients, as follows.

The current structure for enclosing subscription information over the SIP tunnel utilises a specific header referred to as “x-sub-data”, containing the fields:

“x-sub-data: To=W, From=P, Sub-state=1300, Sub-id=2234”

where “W” is the targeted watcher (watching client), “P” is the presentity (observed client), “Sub-state” is the subscription state and “Sub-id” is a unique subscription parameter used as a tunnel parameter. This header structure can thus be utilised for the common notification to multiple watchers in the present solution, by including multiple “x-sub-data” headers in the notification. In the example of FIG. 4, the common notification in step 4:4 would then include the following three headers for the targeted watching clients A₁, A₂ and A₃:

“x-sub-data: To=A₁, From=B, Sub-state=1300, Sub-id=2234”
“x-sub-data: To=A₂, From=B, Sub-state=2400, Sub-id=235”
“x-sub-data: To=A₃, From=B, Sub-state=1567, Sub-id=56f4”

In this solution, the “sub-id” information for a specific watching client can be associated with his/her back-end subscription, as known by the information delivery server which then will be able to locate the correct back-end subscription for each watching client by means of the “sub-id” information. The indication of at least one delivery rule valid for one or more of the watching clients can be included in the common notification, e.g., as an additional field in one or more of the multiple “x-sub-data” headers, or as an additional header or other data field in the message.

According to a second alternative, an existing “id” parameter in the “Event” header of an SIP NOTIFY message can be used to indicate a unique subscription within an SIP dialogue. This can be utilised in the present solution such that the information delivery server creates a single SIP dialogue with the client data server for all watching clients subscribing for client data of the same observed client, and then use the “id” parameter in the “Event” header to indicate the actual subscriptions. The client data server will thus include a list of “id” parameters in a common notification for the watching clients, and the receiving information delivery server will then be able to locate the correct back-end subscription for each watching client by means of the “id” parameters.

In both alternatives, after identifying the correct back-end subscriptions as described above, the information delivery server can customise the client data in the common notification by applying the stored data filters, if any, and the received at least one delivery rule, and deliver the customised client data accordingly.

Using the present invention can greatly reduce the signalling needed for delivering client data of a single observed client to plural watching clients, by sending a single common notification from the client data server to the information delivery server according to the various embodiments described above. It should be noted that otherwise, each individual notification involves transmission of a plurality of messages back and forth for establishing and terminating the dialogue between these nodes.

While the invention has been described with reference to specific exemplary embodiments, the description is generally only intended to illustrate the inventive concept and should not be taken as limiting the scope of the invention, which is defined by the appended claims. The IMS technology and the SIP signalling protocol have been occasionally used when describing the above embodiments, although any other standards and protocols suitable for implementing the present invention may basically be used.

1-24. (canceled)

25. A method executed by an information delivery server for providing client data of an observed client to a plurality of watching clients in a communication network, the method comprising the steps of:
receiving from the watching clients, individual subscription requests for client data of the observed client;
creating with a client data server, back-end subscriptions for client data of the observed client on behalf of the watching clients, the client data server maintaining the client data;
receiving from the client data server, a single notification message containing identifiers of the subscribing watching clients and client data of the observed client;
customizing the client data for each identified watching client by applying at least one delivery rule valid for one or more of the watching clients; and
delivering the customized client data in a plurality of individual notifications sent from the information delivery server to the identified watching clients.

26. The method according to claim 25, wherein the single notification message also includes an indication of the at least one delivery rule.

27. The method according to claim 26, wherein the delivery rule indication states one or more complete rules explicitly.

28. The method according to claim 26, wherein the delivery rule indication states a reference representing the at least one delivery rule implicitly by pointing to rules stored in an accessible delivery rule database or to rules predefined in a look-up table.

29. The method according to claim 25, wherein the information delivery server identifies the watching clients as subscribing to the client data of the observed client, and retrieves the at least one delivery rule from an accessible rules database.

30. The method according to claim 25, further comprising:
receiving data filters for the watching clients with the individual subscription requests; and
wherein the customizing step also includes applying the data filters to the client data of the observed client.

31. The method according to claim 25, wherein the step of receiving the single notification message includes receiving the single notification message from the client data server over an existing Session Initiation Protocol (SIP) tunnel.

32. The method according to claim 31, wherein the identifiers of the watching clients are specified in an x-sub-data header of the single notification message.

33. The method according to claim 25, wherein the step of creating back-end subscriptions with the client data server includes creating a single Session Initiation Protocol (SIP) dialogue with the client data server for the watching clients, wherein an ID parameter in an Event header is used to indicate the back-end subscriptions.

34. The method according to claim 33, wherein the identifiers for the watching clients in the received single notification message comprise a list of ID parameters.

35. An information delivery server for providing client data of an observed client to a plurality of watching clients in a communication network, the information delivery server comprising:
means for receiving from the watching clients, individual subscription requests for client data of the observed client;
means for creating with a client data server, back-end subscriptions for client data of the observed client on behalf of the watching clients, the client data server maintaining the client data;
means for receiving from the client data server, a single notification message containing identifiers of the subscribing watching clients and client data of the observed client;
means for customizing the client data for each identified watching client by applying at least one delivery rule valid for one or more of the watching clients; and
means for delivering the customized client data in a plurality of individual notifications sent from the information delivery server to the identified watching clients.

36. The information delivery server according to claim 35, wherein the single notification message also includes an indication of the at least one delivery rule.

37. The information delivery server according to claim 36, wherein the delivery rule indication states one or more complete rules explicitly.

38. The information delivery server according to claim 36, wherein the delivery rule indication states a reference representing the at least one delivery rule implicitly by pointing to rules stored in an accessible delivery rule database or to rules predefined in a look-up table.

39. The information delivery server according to claim 36, further comprising means for identifying the watching clients as subscribing to the client data of the observed client, and means for retrieving the at least one delivery rule from an accessible rules database.

40. The information delivery server according to claim 35, wherein:
the means for receiving individual subscription requests from the watching clients includes means for receiving data filters for the watching clients with the individual subscription requests; and
the means for customizing the client data includes means for applying the data filters to the client data of the observed client.

41. The information delivery server according to claim 35, wherein the means for receiving the single notification message includes means for receiving the single notification message from the client data server over an existing Session Initiation Protocol (SIP) tunnel.

42. The information delivery server according to claim 35, wherein the means for creating back-end subscriptions with the client data server includes means for creating a single Session Initiation Protocol (SIP) dialogue with the client data server for the watching clients, wherein an ID parameter in an Event header is used to indicate the back-end subscriptions.

43. A client data server for providing client data of an observed client to a plurality of watching clients in a communication network, the client data server comprising:
means for receiving from an intervening information delivery server, requests for back-end subscriptions for client data of the observed client on behalf of the watching clients, wherein each back-end subscription requests includes an identifier of a corresponding watching client; and
means for sending a single notification message to the information delivery server, the single notification message containing identifiers of the subscribing watching clients and client data of the observed client.

44. The client data server according to claim 43, further comprising means for retrieving from a rule database, at least one delivery rule which is valid for one or more of the watching clients, wherein the means for sending the single notification message includes means for including in the single notification message, an indication of the retrieved at least one delivery rule.
